(19) United States
(12) Patent Application Publication
(10) Pub. No.: US 2025/0229807 A1
(43) Pub. Date: Jul. 17, 2025

(54) METHOD OF CONTROLLING VEHICLES, SERVER, VEHICLE, AND COMPUTER READABLE STORAGE MEDIUM THEREOF

(71) Applicants: Foxconn Technology Group Co., Ltd., Shenzhen (CN); HON HAI PRECISION INDUSTRY CO., LTD., New Taipei (TW)

(72) Inventor: NIEN-CHE LI, New Taipei (TW)

(21) Appl. No.: 18/963,893

(22) Filed: Nov. 29, 2024

(30) Foreign Application Priority Data
Jan. 11, 2024 (CN) 202410044334.2

(51) Int. Cl. B60W 60/00

(52) U.S. Cl. CPC B60W 60/0027; B60W 2520/10; B60W 2554/4044; B60W 2556/45

(57) ABSTRACT

A method of controlling vehicles includes that a server invokes a first vehicle with at least including a full self-driving system for autonomous controlling a vehicle to drive after receiving invokable information of the first vehicle and first vehicle information. After receiving first requesting information of requesting stop moving from a second vehicle in a predefined state, the server confirms a vehicle stop strategy according to the first vehicle information and second vehicle information. Then, the first vehicle is determined as a target vehicle according to the vehicle stop strategy and the first vehicle information, and second requesting information is transmitted to the target vehicle. The target vehicle provides a resistance to the second vehicle according to the vehicle stop strategy in response to the second request information, for stopping the movement of the second vehicle. A server, a vehicle, and a computer readable storage medium are also provided.

### TECHNICAL FIELD

The present application generally relates to vehicle controlling technology, and particular to a method of controlling vehicles, a server, a vehicle, and a computer readable storage medium thereof.

### BACKGROUND

When vehicles in a predefined state, such as an out-of-control state, drivers may control the vehicle in out-of-control to crash a roadside infrastructure, such as a buffer zone or roadside railing, for forcing the vehicle to stop moving. While the process of crashing the roadside infrastructure, such as a buffer zone or roadside railing, a safety hazards may occur to pedestrian and other vehicles.

There is room to for improvement in the art.

### BRIEF DESCRIPTION OF THE DRAWINGS

Implementations of the present application will now be described, by way of example only, with reference to the attached figures.

FIG. 1 is a diagram illustrating a first embodiment of an application scenario of a method of controlling vehicles according to the present application.

FIG. 2 is a diagram illustrating a first embodiment of a communication process of a method of controlling vehicles according to the present application.

FIG. 3 is a flowchart illustrating an embodiment of a method of controlling vehicles according to the present application.

FIG. 4 a diagram illustrating a second embodiment of an application scenario of a method of controlling vehicles according to the present application.

FIG. 5 is a flowchart illustrating a second embodiment of a method of controlling vehicles according to the present application.

FIG. 6 is a flowchart illustrating a third embodiment of a method of controlling vehicles according to the present application.

FIG. 7 is a flowchart illustrating a fourth embodiment of a method of controlling vehicles according to the present application.

FIG. 8 is a diagram illustrating an embodiment of a server according to the present application.

FIG. 9 is a diagram illustrating an embodiment of a vehicle according to the present application.

FIG. 10 is a diagram illustrating an embodiment of another vehicle according to the present application.

### DETAILED DESCRIPTION

The term “multiple” of the present application means two or more. In addition, it is understood that, the terms “first”, “second”, and the like used in the present application are merely used for distinction and description, and shall not be understood as an indication or implication of relative importance or an indication or implication of an order.

In this embodiment of this application, the terms such as “example” or “for example” are used to indicate examples, instances, or descriptions. Any embodiment or solution described as “example” or “for example” in the embodiments of this application is not to be construed as being more preferred or advantageous than other embodiments or solutions. Exactly, use of the word “example”, “for example”, or the like is intended to present a relative concept in a specific manner.

In general, the word “module,” as used herein, refers to logic embodied in hardware or firmware, or to a collection of software instructions, written in a programming language, for example, Java, C, or assembly. One or more software instructions in the modules may be embedded in firmware, such as an EPROM, magnetic, or optical drives. It will be appreciated that modules may comprise connected logic units, such as gates and flip-flops, and may comprise programmable units, such as programmable gate arrays or processors, such as a CPU. The modules described herein may be implemented as either software and/or hardware modules and may be stored in any type of computer-readable medium or other computer storage systems. The term “comprising” means “including, but not necessarily limited to”; it specifically indicates open-ended inclusion or membership in a so-described combination, group, series, and the like. The application is illustrated by way of example and not by way of limitation in the figures of the accompanying drawings in which like references indicate similar elements. It should be noted that references to “an” or “one” embodiment in this application are not necessarily to the same embodiment, and such references can mean “at least one.”

A related art is simply described as below.

When vehicles in a predefined state, such as an out-of-control state, drivers may control the vehicle in out-of-control to crash a roadside infrastructure, such as a buffer zone or roadside railing, for forcing the vehicle to stop moving. While the process of crashing the roadside infrastructure, such as a buffer zone or roadside railing, a safety hazards may occur to pedestrian and other vehicles.

Vehicles with a full self-driving system may be named as full self-driving vehicles. The full self-driving vehicles may achieve an automatic driving of the vehicles, under a situation of the driver without controlling a vehicle controlling system. For example, the full self-driving vehicles may drive to a destination according to a predefined driving path and driving speed. When the vehicle in a predefined state is the full self-driving vehicle, if there is no person in the full self-driving vehicle, no person may control the full self-driving vehicle to crash the roadside infrastructure, and the full self-driving vehicle is unable to stop moving, a greater safety hazards may occur to pedestrian and other vehicles by the fully self-driving vehicle.

According to above, the present application provides a method of controlling vehicle, a server, a vehicle, and a computer readable storage medium, for reducing the safety hazards generated by the vehicle in a predefined state.

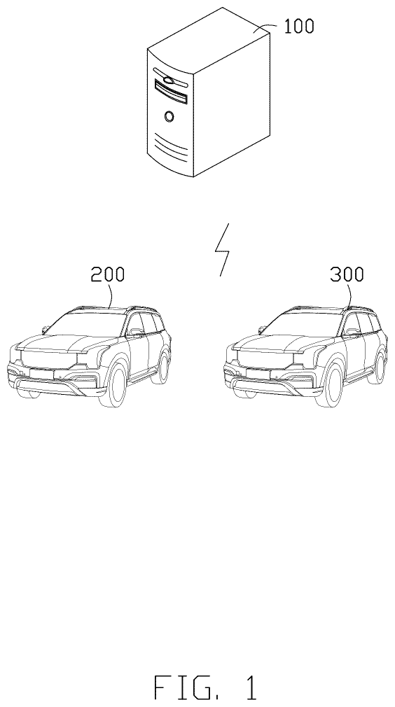

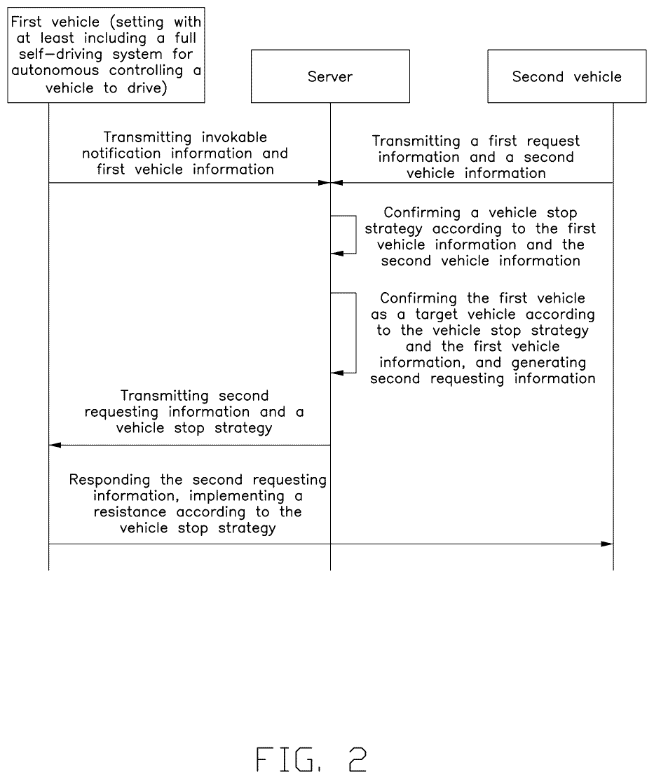

Referring to FIGS. 1 and 2, FIG. 1 is an application scenario of the method of controlling vehicles of the present application. FIG. 2 is a communication process of the method of controlling vehicles of the present application. The method of controlling vehicles is applied to a server 100, a first vehicle 200, and a second vehicle 300. The first vehicle 200 is set with a full self-driving system for autonomous controlling a vehicle to drive. The server 100 establishes communications with the first vehicle 200 and the second vehicle 300 using vehicle to X (V2X) technology. After the server 100 receives invokable notification information transmitted by the first vehicle 200 and first vehicle information, the server 100 may invoke the first vehicle 200 without person and with the full self-driving system for autonomous controlling the vehicle. After the server receives first request information of requesting stop moving from a second vehicle in a predefined state, the server confirms a vehicle stop strategy according to the first vehicle information and second vehicle information. Then, the first vehicle is determined as a target vehicle according to the vehicle stop strategy and the first vehicle information, and second requesting information is generated. Finally, the server transmits the second requesting information and the vehicle stop strategy to the target vehicle. The target vehicle provides a resistance to the second vehicle according to the vehicle stop strategy in response to the second request information, for stopping the movement of the second vehicle.

In some embodiments, the server 100 may be a server 100 of traffic management system, which includes the server 100 and traffic infrastructures. The traffic infrastructures include monitor devices, such as a camera. The monitor device acquires and transmits the first vehicle information of the first vehicle 200 and the second vehicle information of the second vehicle 300 to the server 100, for making the first vehicle information and the second vehicle information received by the server 100 to be more accurate.

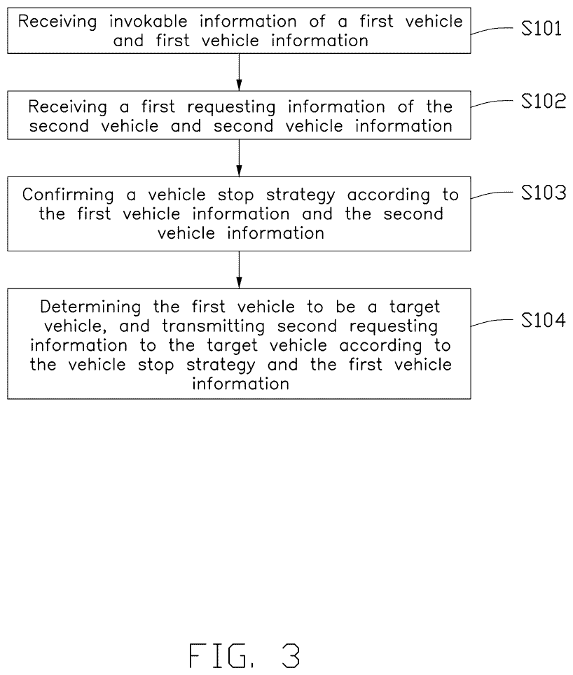

Referring to FIG. 3, FIG. 3 is a flowchart of the method of controlling vehicles. The method of controlling vehicles is applied to the server 100. The method of controlling vehicles includes the following steps.

In block S101, invokable information of a first vehicle and first vehicle information are received.

The first vehicle 20 sets with a full self-driving system for autonomous controlling a vehicle to drive. The first vehicle 200 may be drove under the full self-driving, and the vehicle controlling system of the first vehicle 200 may be controlled by persons. The first vehicle information may include a vehicle position, a vehicle speed, a vehicle weight, and a travelling track of the first vehicle 200. The invokable information indicates that the first vehicle 200 may be invoked by the server 100, and there is no person and dangerous substance in the first vehicle 200. After receiving the invokable information, the server 100 may confirm that the first vehicle 200 without person and dangerous substance may be invoked by the server 100 according to the invokable information. For example, there three first vehicles 200 transmitted information to the server 100. Two of the three first vehicles 200 transmit the invokable information to the server 100, and a rest of the three first vehicles 200 transmit non-invokable information to the server 100. The server 100 is able to invoke two of the three first vehicles 200, and is unable to invoke the rest of the three first vehicles 200.

It is understood that, when the first vehicle 200 without person and dangerous substance, the first vehicle 200 is able to be invoked by the server 100.

In block 102, first requesting information of the second vehicle 300 and second vehicle information are received.

The second vehicle 300 may be the first vehicle 200 set with the fully self-driving system for autonomous controlling a vehicle to drive, also may be a vehicle without the full self-driving system for autonomous controlling a vehicle to drive. The second vehicle information may include a vehicle position, a vehicle speed, a person information, and a travelling track of the second vehicle 300.

It is understood that, when the second vehicle 300 do not set with the full self-driving system for autonomous controlling a vehicle to drive, according to the method of controlling vehicles, a safety hazards occurred to pedestrian and other vehicles may be reduced in a greater degree.

The first requesting information is configured to indicate that the second vehicle 300 requests to the server 100 for stopping moving. In that means, after receiving the first requesting information, the server 100 invokes the first vehicle 200 for making the second vehicle 300 to stop moving in response to the first requesting information.

When the second vehicle 300 is determined to be in a predefined state, the first requesting information is generated. The predefined state includes an out-of-control state, a controlled state, or a person in the vehicle to be a predefined identification. The predefined identification may be a person needed to get off the vehicle immediately, such as a criminal suspect or an escaped criminal. The predefined identification may be set according to actual situation.

It is understood that, after receiving the first requesting information of the second vehicle 300, the server 100 may confirm the second vehicle 300 to be in the predefined state, and invoke the first vehicle 200 for making the second vehicle 300 to stop moving.

In block S103, a vehicle stop strategy is confirmed according to the first vehicle information and the second vehicle information.

The vehicle stop strategy is a strategy for making the second vehicle 300 to stop moving. The vehicle stop strategy may include the first vehicle 200 providing a resistance to the second vehicle 300, and a number, a predicated track, and a predicated speed of the first vehicles 200.

In one embodiment, the server 100 confirms the vehicle stop strategy according to the positions, the driving speeds, and the traveling tracks of the first vehicle 200 and the second vehicle 300. The vehicle stop strategy is that three first vehicles 200 adjacent to the second vehicle 300 is confirmed for providing the resistance to the second vehicle 300 until the second vehicle 300 stops moving. The predicated speeds of the three first vehicles 200 are a first speed, a second speed, and a third speed. The predicated traveling tracks of the three vehicles 200 are a first travelling track, a second travelling track, and a third travelling track. The server 100 may confirm the first vehicle 200 for providing the resistance to the second vehicle 300 according to the position of the second vehicle 300, and a number of the first vehicles 200. The server 100 obtains the predicated speed of each first vehicle 200 after confirmed the speeds of each first vehicle 200 and the second vehicle 300. The server 100 obtains the predicated travelling track of each first vehicle 200 according to the confirmed travelling tracks of each first vehicle 200 and the second vehicle 300.

In block S104, the first vehicle 200 is confirmed as a target vehicle and second requesting information is transmitted to the target vehicle according to the vehicle stop strategy and the first vehicle information.

The target vehicle is the first vehicle 200 providing the resistance to the second vehicle 300 according to the vehicle stop strategy for making the second vehicle 300 to stop moving. As the above example, one of the three target vehicles responses to the second requesting information and provides the resistance to the second vehicle 300 according to the first speed, the first travelling track, until the second vehicle 300 stops moving.

Therefore, after receiving the invokable information of the first vehicle 200 without person and the first vehicle information, the server 100 may invoke the first vehicle 200 without person and set with the fully self-driving system for autonomous controlling a vehicle to drive. After receiving the first requesting information of requesting to stop moving from the second vehicle 300, the server 100 confirms a vehicle stop strategy according to the first vehicle information and the second vehicle information. Then, the first vehicle 200 is determined as a target vehicle according to the vehicle stop strategy and the first vehicle information, and the second requesting information is transmitted to the target vehicle. The target vehicle provides a resistance to the second vehicle 300 according to the vehicle stop strategy in response to the second request information, for stopping the movement of the second vehicle 300.

It is understood that, due to there is no person in the target vehicle set with the fully self-driving system for autonomous controlling the vehicle to drive, casualties in the target vehicle are reduced, which assists the second vehicle 300 to stop moving. The confirmed vehicle stop strategy considers the first vehicle information and the second vehicle information, for making the vehicle stop strategy to be more accurate. The target vehicle accurately provides the resistance to the second vehicle 300 in the predefined state according to the vehicle stop strategy, the safety hazards occurred to pedestrian and other vehicles are reduced.

In some embodiments, the number of the target vehicle are multiple. The multiple target vehicle are some of the first vehicles 200 confirmed according to the vehicle stop strategy and the first vehicle information. The number of the target vehicles are larger than or equal to 2. In detail, the following steps are used for selecting several target vehicles form the first vehicles 200.

In block S201, several the first vehicles are added to an invokable list.

In one embodiment, after receiving the invokable information of the first vehicles 200, the server 100 adds the first vehicles 200 to the invokable list. It is understood that, by the invokable list, the server 100 may invoke the first vehicles 200 in time.

In block S202, some of the first vehicles 200 are confirmed to be the target vehicles according to the vehicle stop strategy.

It is understood that, the vehicle stop strategy of the block S103 includes the first vehicles 200 being able to provide the resistance to the second vehicle 300, and a number of the first vehicles 200. The server 100 may confirm the first vehicles 200 in the invokable list for providing the resistance to the second vehicle 300. The first vehicles 200 are the target vehicles. There is more than one first vehicles 200 in the vehicle stop strategy. Thus, the number of the target vehicles are more than one.

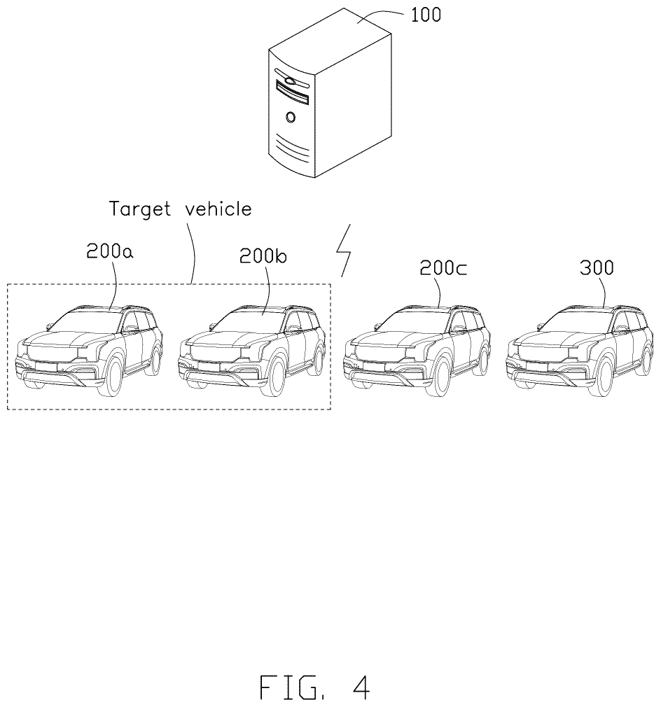

Referring to FIG. 4, in an application scenario of the present application, the server 100 adds the first vehicles 200a, 200b, 200c to the invokable list. After receiving the first requesting information of the second vehicle 300, the server 100 searches the first vehicles 200a and 200b in the invokable list to be adjacent to the position of the second vehicle 300. Thus, the server 100 confirms the first vehicles 200a and 200b to be the target vehicles.

In some embodiments, the block S202 includes the following steps.

In block S301, some of the first vehicles 200 in the invokable list are confirmed to be the target vehicles according to the vehicle stop strategy and the first vehicles with the weight ordered in ascending sequence.

In the vehicle stop strategy, there are multiple first vehicles 200 capable of providing the resistance to the second vehicle 300. The server 100 may combinate the weight of the first vehicle 200 for confirming the target vehicles from the first vehicles 200 in the invokable list.

In one embodiment, the first vehicles 200 confirmed by the server 100 for providing the resistance to the second vehicle 300 according to the vehicle stop strategy are a car and a truck. By comparing the weights of the car and the truck, the truck with a heavier weight to be the target vehicle.

In some embodiment, after the first vehicles 200 are confirmed as the target vehicles according to the vehicle stop strategy and the first vehicle information, the method of controlling vehicles further includes the following steps.

In block S401, third requesting information is transmitted to the target vehicle for making the target vehicle to transmit vehicle control permission information.

After the target vehicles are confirmed, the server 100 also generates the third requesting information. The third requesting information indicates that the vehicle control permission information transmitted by the target vehicle. In other words, the target vehicles transmits the vehicle control permission information to the server 100 in response to the third requesting information.

In block S402, the vehicle control permission information transmitted by the target vehicles is received.

It is understood that, after the vehicle control permission of the target vehicle is transferred to the server 100, the server 100 may control the target vehicles. In other words, the server 100 may send control instructions to the target vehicles. The target vehicles execute actions corresponding to the control instructions in response to the control instructions. For example, the server 100 sends a control instruction of driving in a first speed to the target vehicles, the target vehicles drives in the first speed in response to the control instruction.

In block S403, the target vehicle provides the resistance to the second vehicle 300 based on the vehicle control permission information for making the second vehicle 300 to stop moving.

In one embodiment, the server 100 controls one target vehicle to drive in the first speed and move along a first travelling track for providing the resistance to the second vehicle 300 based on the vehicle control permission information until the second vehicle 300 stops moving.

It is understood that, after the target vehicle is confirmed, there are two ways for invoking the target vehicles. In one way, the server 100 transmits the second requesting information and the vehicle stop strategy to the target vehicle, for making the target vehicle to provide the resistance according to the second vehicle 300. In another way, the server 300 transmits the third requesting information to the target vehicle, for requesting the target vehicle to transfer the vehicle control permission information to itself, and then the server 100 controls the target vehicle to provide the resistance to the second vehicle 300 according to the vehicle stop strategy.

In some embodiments, the block of confirming the vehicle stop strategy according the first vehicle information and the second vehicle information includes the following steps.

In block S501, a predicated travelling track and/or a predicated speed of the vehicle stop strategy is confirmed according to the first vehicle information, person information in the second vehicle 300 and/or a degree of the second vehicle 300 in out-of-control.

The second vehicle information also includes the person information in the second vehicle 300 and a degree of the second vehicle 300 in out-of-control. The person information may be a pregnant women, kids, and old man, and so on. It is understood that, the server 100 further combinate the person information in the second vehicle 300 and the degree of the second vehicle 300 being out-of-control to confirm the vehicle stop strategy.

In one embodiment, when the received second vehicle information indicates there is a pregnant women in the second vehicle 300, the server 100 slows down the predicated speed of the target vehicle, for avoiding a strongly crash to the second vehicle 300 generated by the target vehicle, thus an injure to the pregnant women is reduced.

The degree of the vehicle in out-of-control may be a complete out-of-control or a part out-of-control. When the degree of the vehicle in out-of-control is a complete out-of-control, there is no response while the person executes any operations to the vehicle. When the degree of the vehicle in out-of-control is a part out-of-control, the vehicle may response according to some operations executed by the person. For example, when the break of the vehicle failed and the steering wheel of the vehicle may work, it is determined that the degree of the vehicle in out-of-control is the part out-of-control. In one embodiment, the break of the second vehicle 300 failed and the driver rotates the steering wheel of the second vehicle 300 to control the second vehicle 300 to crash a buffer zone. The server 100 confirms the predicated travelling track in the vehicle stop strategy according to the operation of rotating the steering wheel of the second vehicle 300, and cooperates the operation of rotating the steering wheel of the second vehicle 300 for making the predicated travelling track to be matched with the second vehicle 300, therefore, the target vehicle may accurately provide the resistance to the second vehicle 300.

It is understood that, the vehicle stop strategy updates and confirm in time according to the first vehicle information and the second vehicle information. For example, when there is the pregnant women in the second vehicle 300 or the degree of the vehicle in out-of-control is a complete out-of-control, for making the vehicle stop strategy to be more safe and accurate.

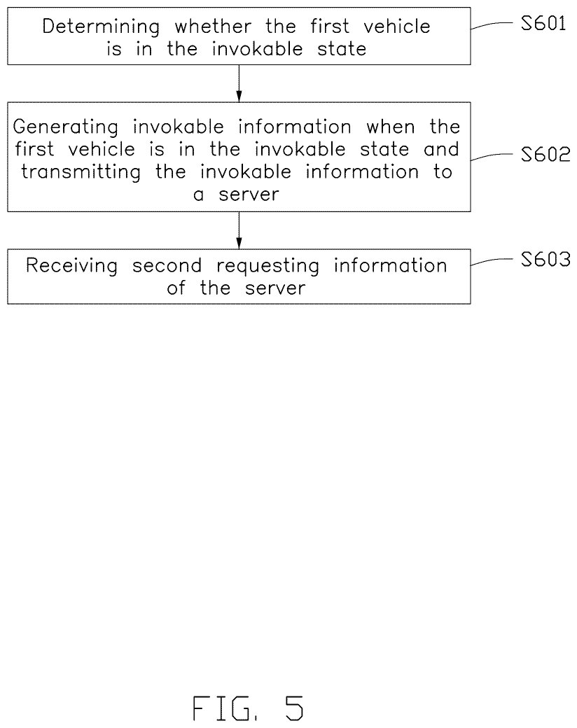

The present application also provides a method of controlling vehicles. The method of controlling vehicles is applied to the first vehicle 200 set with a fully self-driving system for autonomous controlling a vehicle to drive. Referring to FIG. 5, the method of controlling vehicles includes the following steps.

In block S601, determining whether the first vehicle 200 is in an invokable state.

The invokable state of the first vehicle 200 may be confirmed by determining whether there is passengers in the first vehicle 200. When there is passengers in the first vehicle 200, the first vehicle 200 is in the invokable state. When there is no passenger in the first vehicle 200, the first vehicle 200 is in a non-involved state.

In block S602, invokable information is generated and transmitted to the server 100 when the first vehicle 200 is in the invokable state.

Then, the invokable information is generated according to the first vehicle 200 in the invokable state. It is understood that, when there is no passenger in the first vehicle 200, the first vehicle 200 may serve as the vehicle assisting the second vehicle 300 to stop moving, thus the invokable information is generated. When there is passenger in the first vehicle 200, the first vehicle 200 fails to assist the second vehicle 300 to stop moving, thus the non-invokable information is generated, for avoiding the passengers in the first vehicle 200 to be injured.

After the first vehicle 200 generates the invokable information, the invokable information is transmitted to the server 100. In some embodiments, after the first vehicle 200 generates the non-invokable information, the non-invokable information is also transmitted to the server 100. The server 100 does not invoke the first vehicle 200 after receiving the corresponding non-invokable information.

In block S603, the second requesting information is received.

The second requesting information indicates that the first vehicle 200 provides the resistance to the second vehicle 300 according to the vehicle stop strategy, for making the second vehicle to stop moving.

In one embodiment, the first vehicle 200 responses to the second requesting information and provides the resistance to the second vehicle 300 in the first speed and along the first travelling track, until the second vehicle 300 stops moving. It is understood that, when the first vehicle 200 receives the second requesting information, it is determined that the first vehicle 200 is confirmed as the target vehicle by the server 100. The first vehicle 200 is configured to provide the resistance to the second vehicle 300.

Thus, by determining whether there are passengers in the first vehicle 200, the invokable information is generated when there is no passenger in the first vehicle 200 and transmitted to the server 100, for prompting the server 100 to invoke the first vehicle 200. Then, the first vehicle 200 receives the second requesting information generated by the server 100, and response to the second requesting information to provide the resistance to the second vehicle 300 according to the vehicle stop strategy, for making the second vehicle 300 to stop moving. It is understood that, the first vehicle 200 without passengers and set with the fully self-driving system for autonomous controlling the vehicle to drive provides the resistance to the second vehicle 300 according to the vehicle stop strategy, for reducing casualties in the first vehicle 200 while assisting the second vehicle 300 to stop moving. The first vehicle 200 may accurately provide the resistance to the second vehicle 300 according to the vehicle stop strategy, the safety hazards occurred to pedestrian and other vehicles are reduced.

In some embodiments, the method of controlled vehicles further includes the following step. In block S701, the vehicle control permission of the first vehicle 200 is transmitted to the server 100 according to the third requesting information of the server 100.

After receiving the third requesting information from the server 100, the first vehicle 200 responses the third requesting information and transfers the itself vehicle control permission to the server 100, for making the server 100 to directly control the first vehicle 200.

In some embodiments, after transmitting the invokable information to the server 100, the method of controlling vehicles further includes the following step. In block S801, notification information of the first vehicle 200 being invoked is transmitted to a booking client.

The booking client indicates a client for booking the invokable first vehicle 200. The client may be a mobile phone, a computer, a smart watch, and so on. In one embodiment, the first vehicle 200 transmits the invokable information to the server 100, then transmits the notification information of the first vehicle 200 being invoked. For example, the information of “the first vehicle you booked is invoked” is transmitted to the client, for making the users to notice a situation of the booked vehicle to be unable to take, a follow-up trip is arranged according to the situation, for avoiding wasting users time.

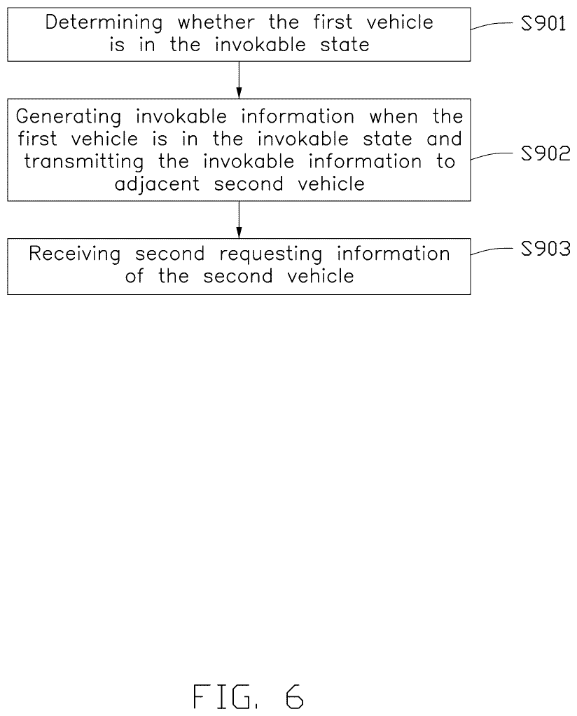

The present application also provides a method of controlling vehicles applied to the first vehicle 200. Referring to FIG. 6, the method of controlling vehicles includes the following steps.

In block S901, determining whether the first vehicle 200 is in the invokable state.

It is understood that, the manner for confirming the invokable state of the first vehicle 200 may refer to the blocks S601 and S602.

In block S902, the invokable information is transmitted to the second vehicle 300 when the first vehicle 200 is in the invokable state.

It is understood that, the method of controlling vehicles of the present application also may be directly applied between the first vehicle 200 and the second vehicle 300. In other words, after the invokable information generated by the first vehicle 200, the first vehicle 200 transmits the invokable information to the second vehicle 300. The second vehicle 300 as a target may be distanced from the first vehicle 200 in a predefined distance (such as adjacent to) or being communicated with the first vehicle 200. The predefined distance may be set according to actual situation.

It is understood that, after determining the first vehicle 200 is in the invokable state, the first vehicle 200 makes the vehicle stop strategy according to the second vehicle information of the second vehicle 300 adjacent to or being communicated with, and the first vehicle information of itself. The detail making manner and the content of the vehicle stop strategy may refer to the steps of the server 100.

In block S903, the second requesting information is received.

The second requesting information indicates that the first vehicle 200 provides the resistance to the second vehicle 300 according to the vehicle stop strategy, for making the second vehicle 300 to stop moving. It is understood that, as above recited, the second requesting information is configured to indicate the first vehicle 200 provides the resistance to the second vehicle 300 according to the vehicle stop strategy, for making the second vehicle 300 to stop moving.

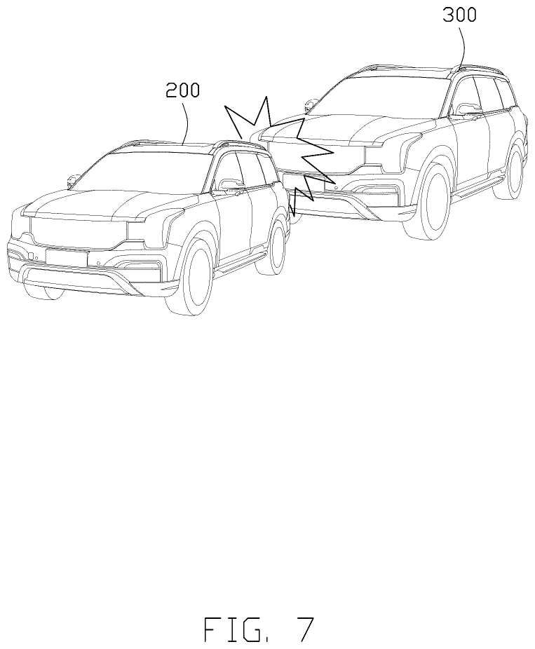

Referring to FIG. 7, after receiving the second requesting information, the first vehicle 200 responses to the second requesting information and provides the resistance to the second vehicle 300 according to the vehicle stop strategy, until the second vehicle 300 stops moving.

It is understood that, the method of controlling vehicles directly applies between the first vehicle 200 and the second vehicle 300, and is suitable to a road section without being managed by the traffic management system.

The present application also provides a method of controlling vehicles applied to the second vehicle 300. The method of controlling vehicles includes the following steps.

In block S1001, the first requesting information is generated when the second vehicle 300 is in the predefined state, and transmitted to the server 100.

The predefined state includes an out-of-control state, a controlled state, or a person in the vehicle to be a predefined identification. The predefined identification may be a person needed to get off the vehicle immediately, such as a criminal suspect or an escaped criminal. The predefined identification may be set according to actual situation.

No matter whether the second vehicle 300 is in the out-of-control state, the controlled state, or a person in the second vehicle 300 to be a predefined identification, the second vehicle 300 serves as the vehicle being provided with the resistance. For example, while being traffic controlled, the second vehicle 300 is in the controlled state, the server 100 may invoke the target vehicle to provide the resistance to the second vehicle 300, for assisting traffic controlling. For another example, when the passenger in the second vehicle 300 is a criminal suspect, the server 100 may invoke the target vehicle to provide the resistance to the second vehicle 300, for assisting police to catch the criminal suspect.

It is understood that, the second vehicle 300 generates the first requesting information when the second vehicle 300 is in the predefined state, and requests the server 100 to assist itself to stop moving.

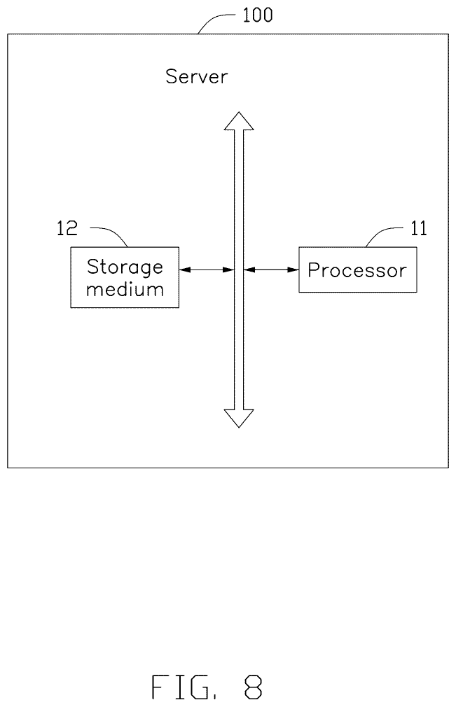

Referring to FIG. 8, the embodiment of the present application also provides a server 100. The server 100 includes a processor 11 and a storage medium 12. The server 100 includes a terminal that can automatically perform numerical calculation and/or information processing according to a preset or pre-stored instruction. Hardware of the terminal includes but is not limited to a microprocessor, an application specific integrated circuit, a field-programmable gate array, a digital processor, an embedded device, and the like. As an example, the storage medium 12 is configured to store program codes and various data. The storage medium 12 may include a Read-Only Memory (ROM), a Random Access Memory (RAM), a Programmable Read-Only Memory (PRAM), a Erasable Programmable Read-Only Memory (EPROM), a One-time Programmable Read-Only Memory (OTPROM), an Electrically-Erasable Programmable Read-Only Memory (EEPROM), a Compact Disc Read-Only Memory (CD-ROM), or other optical disc memories, optical disc memories, a magnetic disk storage medium or other magnetic storage devices, or any other computer-readable medium that can be used to carry or store data.

As an example, the processor 11 may include an integrated circuit. For example, the processor 11 may include a single packaged integrated circuit, or may include a plurality of packaged integrated circuits that have a same function or different functions, including one or more central processing units (central processing units, CPUs), a microprocessor, a digital processing chip, a graphics processing unit, and a combination of various control chips. The processor 11 is a control unit (Control Unit) of the server 100, and executes various functions of the server 100 and performs data processing by running or executing a program or a module stored in the storage medium 12 and invoking data stored in the storage medium 12, for example, executing a multi-device communication function. The foregoing integrated unit implemented in a form of a software functional module may be stored in a computer readable storage medium. The software functional module is stored in a storage medium and includes several instructions for instructing a computer device (which may be a personal computer, a terminal, or a network device) or a processor 11 to perform a part or all of the blocks S101-S104, the blocks S201-S202, the block S301, the blocks 401-S403, and the block S501 described in embodiments of this application. The storage medium 12 stores program codes, and the processor 11 may invoke the program code stored in the storage medium 12 to execute a related function. In an embodiment of this application, the storage medium 12 stores a plurality of instructions, and the plurality of instructions are executed by the processor 11 to implement a part or all of the blocks S101-S104, the blocks S201-S202, the block S301, the blocks 401-S403, and the block S501 of the method of controlling vehicle described in embodiments of this application. Specifically, for a specific method for implementing the foregoing instruction by the processor 11, refer to descriptions of related steps in the embodiments. Details are not described herein again.

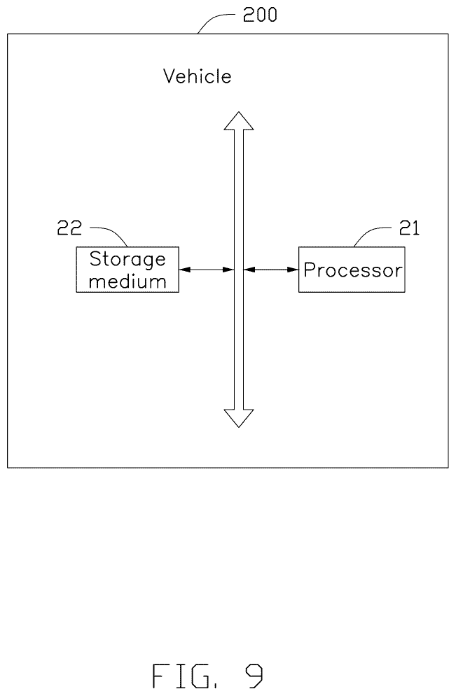

Referring to FIG. 9, the embodiment of the present application also provides a vehicle 200. The vehicle 200 includes a processor 21 and a storage medium 22. The vehicle 200 includes a terminal that can automatically perform numerical calculation and/or information processing according to a preset or pre-stored instruction. Hardware of the terminal includes but is not limited to a microprocessor, an application specific integrated circuit, a field-programmable gate array, a digital processor, an embedded device, and the like. As an example, the storage medium 22 is configured to store program codes and various data. The storage medium 22 may include a Read-Only Memory (ROM), a Random Access Memory (RAM), a Programmable Read-Only Memory (PRAM), a Erasable Programmable Read-Only Memory (EPROM), a One-time Programmable Read-Only Memory (OTPROM), an Electrically-Erasable Programmable Read-Only Memory (EEPROM), a Compact Disc Read-Only Memory (CD-ROM), or other optical disc memories, optical disc memories, a magnetic disk storage medium or other magnetic storage devices, or any other computer-readable medium that can be used to carry or store data.

As an example, the processor 21 may include an integrated circuit. For example, the processor 21 may include a single packaged integrated circuit, or may include a plurality of packaged integrated circuits that have a same function or different functions, including one or more central processing units (central processing units, CPUs), a microprocessor, a digital processing chip, a graphics processing unit, and a combination of various control chips. The processor 21 is a control unit (Control Unit) of the vehicle 200, and executes various functions of the vehicle 200 and performs data processing by running or executing a program or a module stored in the storage medium 22 and invoking data stored in the storage medium 22, for example, executing a multi-device communication function. The foregoing integrated unit implemented in a form of a software functional module may be stored in a computer readable storage medium. The software functional module is stored in a storage medium and includes several instructions for instructing a computer device (which may be a personal computer, a terminal, or a network device) or a processor 21 to perform a part or all of the blocks S601-S603, the block S701, and the block S801 described in embodiments of this application, or perform a part or all of the blocks S901-S903 described in embodiments of this application. The storage medium 22 stores program codes, and the processor 21 may invoke the program code stored in the storage medium 22 to execute a related function. In an embodiment of this application, the storage medium 22 stores a plurality of instructions, and the plurality of instructions are executed by the processor 21 to implement a part or all of the blocks S601-S603, the block S701, and the block S801 of the method of controlling vehicle described in embodiments of this application, or perform a part or all of the blocks S901-S903 of the method of controlling vehicle described in embodiments of this application. Specifically, for a specific method for implementing the foregoing instruction by the processor 21, refer to descriptions of related steps in the embodiments. Details are not described herein again.

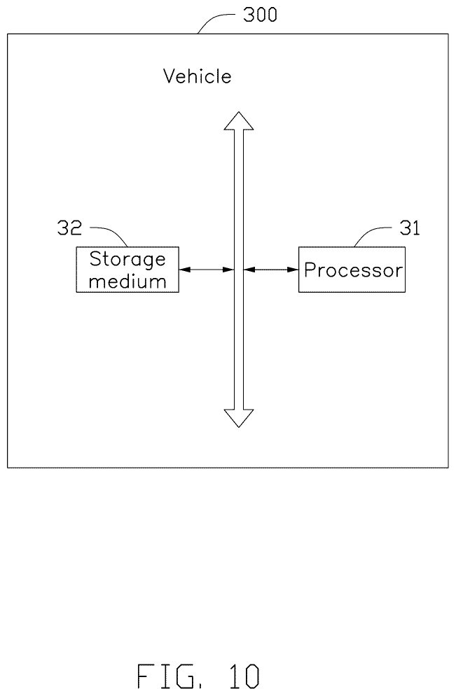

Referring to FIG. 10, the embodiment of the present application also provides a vehicle 300. The vehicle 300 includes a processor 31 and a storage medium 32. The vehicle 300 includes a terminal that can automatically perform numerical calculation and/or information processing according to a preset or pre-stored instruction. Hardware of the terminal includes but is not limited to a microprocessor, an application specific integrated circuit, a field-programmable gate array, a digital processor, an embedded device, and the like. As an example, the storage medium 32 is configured to store program codes and various data. The storage medium 32 may include a Read-Only Memory (ROM), a Random Access Memory (RAM), a Programmable Read-Only Memory (PRAM), a Erasable Programmable Read-Only Memory (EPROM), a One-time Programmable Read-Only Memory (OTPROM), an Electrically-Erasable Programmable Read-Only Memory (EEPROM), a Compact Disc Read-Only Memory (CD-ROM), or other optical disc memories, optical disc memories, a magnetic disk storage medium or other magnetic storage devices, or any other computer-readable medium that can be used to carry or store data.

As an example, the processor 31 may include an integrated circuit. For example, the processor 31 may include a single packaged integrated circuit, or may include a plurality of packaged integrated circuits that have a same function or different functions, including one or more central processing units (central processing units, CPUs), a microprocessor, a digital processing chip, a graphics processing unit, and a combination of various control chips. The processor 31 is a control unit (Control Unit) of the vehicle 300, and executes various functions of the vehicle 300 and performs data processing by running or executing a program or a module stored in the storage medium 32 and invoking data stored in the storage medium 32, for example, executing a multi-device communication function. The foregoing integrated unit implemented in a form of a software functional module may be stored in a computer readable storage medium. The software functional module is stored in a storage medium and includes several instructions for instructing a computer device (which may be a personal computer, a terminal, or a network device) or a processor 31 to perform a part or all of the block S1001 described in embodiments of this application. The storage medium 32 stores program codes, and the processor 31 may invoke the program code stored in the storage medium 32 to execute a related function. In an embodiment of this application, the storage medium 32 stores a plurality of instructions, and the plurality of instructions are executed by the processor 31 to implement a part or all of the block S1001 of the method of controlling vehicle described in embodiments of this application. Specifically, for a specific method for implementing the foregoing instruction by the processor 31, refer to descriptions of related steps in the embodiments. Details are not described herein again.

The present application further provides a computer readable storage medium. The computer readable storage medium stores computer programs. The computer programs are executed by the processor to implement the above recited method of controlling vehicle.

A person of ordinary skill in the art may be aware that, in combination with the examples described in the embodiments disclosed in this specification, units and algorithm steps may be implemented by electronic hardware or a combination of computer software and electronic hardware. Whether the functions are performed by hardware or software depends on particular applications and design constraint conditions of the technical solutions. A person skilled in the art may use different methods to implement the described functions for each particular application, but it should not be considered that the implementation goes beyond the scope of this application. It may be clearly understood by a person skilled in the art that, for convenient and brief description, for a detailed working process of the foregoing system, apparatus, and unit, refer to a corresponding process in the foregoing method embodiments, and details are not described herein again.

It could be appreciated by those skilled in the art that, the present application is not limited by the particular embodiments described herein, various changes, readjustment and replacement can be made by those skilled in the art without departing from the protection scope of the present application. Therefore, although the present application is illustrated in detail through the above embodiments, the present application is not only limited to the above embodiments, more other equivalent embodiments can be included without departing from the concept of the present application, and the scope of the present application is determined by the scope of the attached claims.

What is claimed is:

1. A method of controlled vehicles used in a server; the server comprises a processor and a storage medium; the processor executes computer programs stored in the storage medium to implement following processes:
receiving invokable information of at least one first vehicle and first vehicle information; the invokable information is configured to indicate the corresponding first vehicle is in an invokable state; the first vehicle sets with a fully self-driving system for autonomous controlling a vehicle to drive;
receiving first requesting information of a second vehicle and second vehicle information; when the second vehicle is in a predefined state, the first requesting information is generated, the first requesting information indicates that the second vehicle requests the server to assist itself to stop moving;
confirming a vehicle stop strategy according to the first vehicle information and the second vehicle information; and
confirming at least one first vehicle as a target vehicle according to the vehicle stop strategy and the first vehicle information, and transmitting second requesting information to the target vehicle, thereby making the target vehicle to provide a resistance to the second vehicle according to the vehicle stop strategy, and making the second vehicle to stop moving.

2. The method of claim 1, wherein there are several first vehicles; a number of the target vehicles is more than one; the target vehicles are selected from the first vehicles according to the vehicle stop strategy and the first vehicle information.

3. The method of claim 1, wherein after confirming at least one first vehicle as a target vehicle according to the vehicle stop strategy and the first vehicle information, the method further comprises:
transmitting a third requesting information to the target vehicle, thereby making the target vehicle to transmit vehicle control permission information;
receiving the vehicle control permission information transmitted by the target vehicle; and
controlling the target vehicle to provide the resistance to the second vehicle based on the vehicle control permission information thereby making the second vehicle to stop moving.

4. The method of claim 1, wherein confirming the vehicle stop strategy according to the first vehicle information and the second vehicle information comprises:
confirming a predicated travelling track and/or a predicated speed of the vehicle stop strategy according to the first vehicle information, person information in the second vehicle and/or a degree of the second vehicle in out-of-control.

5. A method of controlling vehicles used in a first vehicle equipped with a fully self-driving system for autonomous controlling a vehicle to drive; the first vehicle further comprises a processor and a storage medium; the processor executes computer programs stored in the storage medium to implement following processes:
determining whether the first vehicle is in an invokable state;
when the first vehicle is in the invokable state, transmitting invokable information to a server; and
receiving second requesting information of the server, the second requesting information indicates that the first vehicle provides the resistance to a second vehicle according to a vehicle stop strategy, thereby making the second vehicle to stop moving.

6. The method of claim 5 further comprising:
transmitting vehicle control permission information of the first vehicle to the server in response to the third requesting information of the server.

7. A method of controlling vehicles used in a first vehicle equipped with a fully self-driving system for autonomous controlling a vehicle to drive; the first vehicle further comprises a processor and a storage medium; the processor executes computer programs stored in the storage medium to implement following processes:
determining whether the first vehicle is in an invokable state;
when the first vehicle is in the invokable state, transmitting invokable information to a second vehicle; and
receiving second requesting information of the second vehicle, the second requesting information indicates that the first vehicle provides the resistance to the second vehicle according to a vehicle stop strategy, thereby making the second vehicle to stop moving.

8. A server comprises:
a storage medium; and
at least one processor;
wherein the storage medium stores computer programs; and the at least one processor executes the computer programs to implement following processes:
receiving invokable information of at least one first vehicle and first vehicle information;
the invokable information is configured to indicate the corresponding first vehicle is in an invokable state; the first vehicle sets with a fully self-driving system for autonomous controlling a vehicle to drive;
receiving first requesting information of a second vehicle and second vehicle information;
when the second vehicle is in a predefined state, the first requesting information is generated, the first requesting information indicates that the second vehicle requests the server to assist itself to stop moving;
confirming a vehicle stop strategy according to the first vehicle information and the second vehicle information; and
confirming at least one first vehicle as a target vehicle according to the vehicle stop strategy and the first vehicle information, and transmitting second requesting information to the target vehicle, thereby making the target vehicle to provide a resistance to the second vehicle according to the vehicle stop strategy, and making the second vehicle to stop moving.

9. The server of claim 8, wherein there are several first vehicles; a number of the target vehicles is more than one; the target vehicles are selected from the first vehicles according to the vehicle stop strategy and the first vehicle information.

10. The server of claim 8, wherein after confirming at least one first vehicle as a target vehicle according to the vehicle stop strategy and the first vehicle information, the method further comprises:
transmitting a third requesting information to the target vehicle, for making the target vehicle to transmit vehicle control permission information;
receiving the vehicle control permission information transmitted by the target vehicle; and controlling the target vehicle to provide the resistance to the second vehicle based on the vehicle control permission information for making the second vehicle to stop moving.

11. The server of claim 8, wherein confirming the vehicle stop strategy according to the first vehicle information and the second vehicle information comprises:
confirming a predicated travelling track and/or a predicated speed of the vehicle stop strategy according to the first vehicle information, person information in the second vehicle and/or a degree of the second vehicle in out-of-control.

12. A vehicle comprises:
a storage medium; and
at least one processor;
wherein the storage medium stores computer programs; and the at least one processor executes the computer programs to implement following processes:
determining whether the first vehicle is in an invokable state;
when the first vehicle is in the invokable state, transmitting invokable information to a server or a second vehicle; and
receiving second requesting information of the server or the second vehicle, the second requesting information indicates that the first vehicle provides the resistance to a second vehicle according to a vehicle stop strategy, for making the second vehicle to stop moving.

13. The vehicle of claim 12, wherein when transmitting invokable information to the server; and receiving the second requesting information of the server; the processor further:
transmitting vehicle control permission information of the first vehicle to the server in response to the third requesting information of the server.

14. A computer readable storage medium comprises a storage medium and a processor; the storage medium stores instructions being executed by the processor to implement following steps:
receiving invokable information of at least one first vehicle and first vehicle information; the invokable information is configured to indicate the corresponding first vehicle is in an invokable state; the first vehicle sets with a fully self-driving system for autonomous controlling a vehicle to drive;
receiving first requesting information of a second vehicle and second vehicle information; when the second vehicle is in a predefined state, the first requesting information is generated, the first requesting information indicates that the second vehicle requests the server to assist itself to stop moving;
confirming a vehicle stop strategy according to the first vehicle information and the second vehicle information; and
confirming at least one first vehicle as a target vehicle according to the vehicle stop strategy and the first vehicle information, and transmitting second requesting information to the target vehicle, thereby making the target vehicle to provide a resistance to the second vehicle according to the vehicle stop strategy, and making the second vehicle to stop moving.

15. The computer readable storage medium of claim 14, wherein there are several first vehicles; a number of the target vehicles is more than one; the target vehicles are selected from the first vehicles according to the vehicle stop strategy and the first vehicle information.

16. The computer readable storage medium of claim 14, wherein after confirming at least one first vehicle as a target vehicle according to the vehicle stop strategy and the first vehicle information, the method further comprises:
transmitting a third requesting information to the target vehicle, thereby making the target vehicle to transmit vehicle control permission information;
receiving the vehicle control permission information transmitted by the target vehicle; and
controlling the target vehicle to provide the resistance to the second vehicle based on the vehicle control permission information for making the second vehicle to stop moving.

17. The computer readable storage medium of claim 14, wherein confirming the vehicle stop strategy according to the first vehicle information and the second vehicle information comprises:
confirming a predicated travelling track and/or a predicated speed of the vehicle stop strategy according to the first vehicle information, person information in the second vehicle and/or a degree of the second vehicle in out-of-control.

18. The computer readable storage medium of claim 14, the target vehicle is confirmed according to the vehicle stop strategy and the first vehicles with the weight ordered in ascending sequence.
